(19) United States
(12) Patent Application Publication
(10) Pub. No.: US 2022/0089373 A1
(43) Pub. Date: Mar. 24, 2022

(54) TUBULAR GRIPPER

(71) Applicant: Arsenal Safety Solutions LLC, Houston, TX (US)

(72) Inventor: MATTHEW BREGMAN, Houston, TX (US)

(73) Assignee: Arsenal Safety Solutions LLC, Houston, TX (US)

(21) Appl. No.: 17/479,800

(22) Filed: Sep. 20, 2021

Related U.S. Application Data
(60) Provisional application No. 63/080,331, filed on Sep. 18, 2020.

(51) Int. Cl. B65G 7/12

(52) U.S. Cl. CPC B65G 7/12

(57) ABSTRACT

A tool for lifting, rotating, and/or manipulating tubulars comprises an inserting head positioned at the end of a shaft acting as a handle. The insertion head comprises a conical shape defined by smaller-diameter end cap, a larger-diameter rear cap, and frame bars connecting the two. On the frame bars are mounted rails along the angle of the conical shape, and slips having a negative angle corresponding to the conical angle of the rails. In use, the head is inserted into a tubular, which abuts a flared portion of the slips and pushes them back along the rails, until the slips make contact with the inner diameter of the tubular, enabling it to be pushed around and lifted.

### RELATED APPLICATIONS

The present application claims priority to and benefit from provisional application having Ser. No. 63/080,331, filed on 18 Sep. 2020, and titled “Tubular Gripper.” The contents of the above-referenced provisional application are incorporated herein by reference.

### FIELD

The present application relates, in general, to a hand tool for insertion into a tubular, allowing a user to grip, roll, and otherwise manipulate the tubular from the inside, onto and off of a group of horizontally stacked tubulars, without risk of hand injury from pinching.

### BACKGROUND

In the oil & gas industry, as well as many others, tubulars are often stacked horizontally on top of each other. These often require two workers to roll or lift the tubular off the stack, which can lead to hand injuries from pinching.

Hand tools exist which permit individual workers to manipulate tubulars, but these are often gripping tools that require the tubular to be gripped from the outside, which can be difficult when the tubular is on top of other tubulars in a loose stack. Other tools can be inserted into the tubular and roll it from the inside, but these tools utilize wheel inserts must be changed out in order to mobilize tubulars having differing diameters.

A need exists for a tubular manipulation tool which can be utilized with tubulars of varying diameters.

Embodiments of the apparatus, disclosed herein, achieve these needs.

### BRIEF DESCRIPTION OF THE DRAWINGS

In the detailed description of various embodiments usable within the scope of the present disclosure, presented below, reference is made to the accompanying drawings, in which:

FIGS. 1A-1B depict an embodiment of the manipulation tool, in perspective and cross-section.

FIGS. 2A-2B depict an embodiment of the inserting portion of a manipulation tool, in perspective view.

FIGS. 3A-3B depict an embodiment of the inserting portion of a manipulation tool, in front view.

FIGS. 4A-4B depict an embodiment of the inserting portion of a manipulation tool, in side view (with partial cross-section).

One or more embodiments are described below with reference to the listed Figure(s).

### DETAILED DESCRIPTION OF THE EMBODIMENTS

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, means of operation, structures and location, methodology, and use of mechanical equivalents may be made without departing from the spirit of the invention.

As well, it should be understood that the drawings are intended to illustrate and plainly disclose presently preferred embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

In general, the present invention includes a tool comprising an inserting portion and a handling portion. The handling portion comprises an extended bar and the inserting portion a series of slip-type grips slidably mounted onto a blunted cone, which in turn is mounted onto an end of the handling portion. When the tool is inserted into a tubular with moderate force, the grips slide outward along the blunted cone until they contact the inner surface of the tubular, allowing the tubular to be rolled or lifted from the handling portion, eliminating the risk of hand injuries.

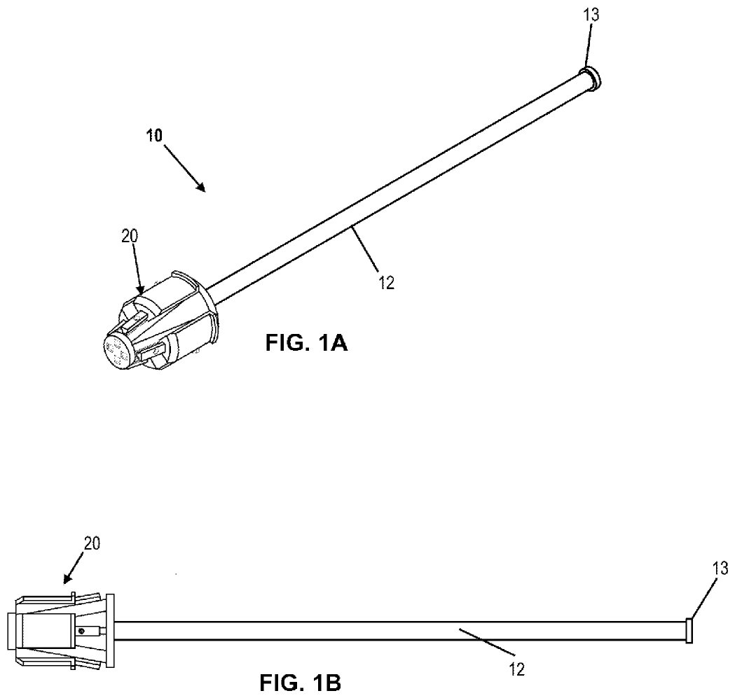

Turning first to FIGS. 1A and 1B depict an embodiment of the inventive handling tool 10 having a handling portion 12 and an inserting portion 20. The handling portion 12 comprises a shaft with a distal end 13. In use, the handling portion 12 remains entirely outside the tubular, with only the inserting portion 20 contacting the tubular, and the user manipulates the handling tool 10 entirely from the handling portion 12.

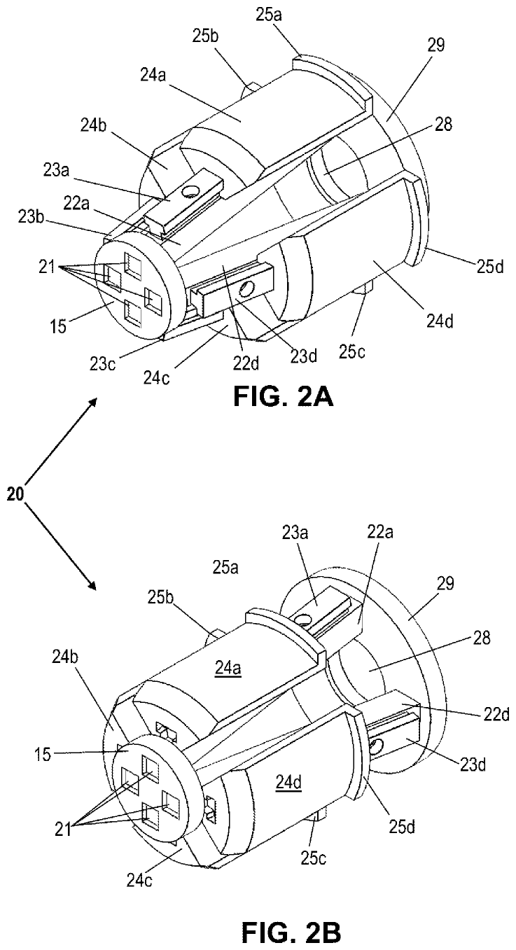

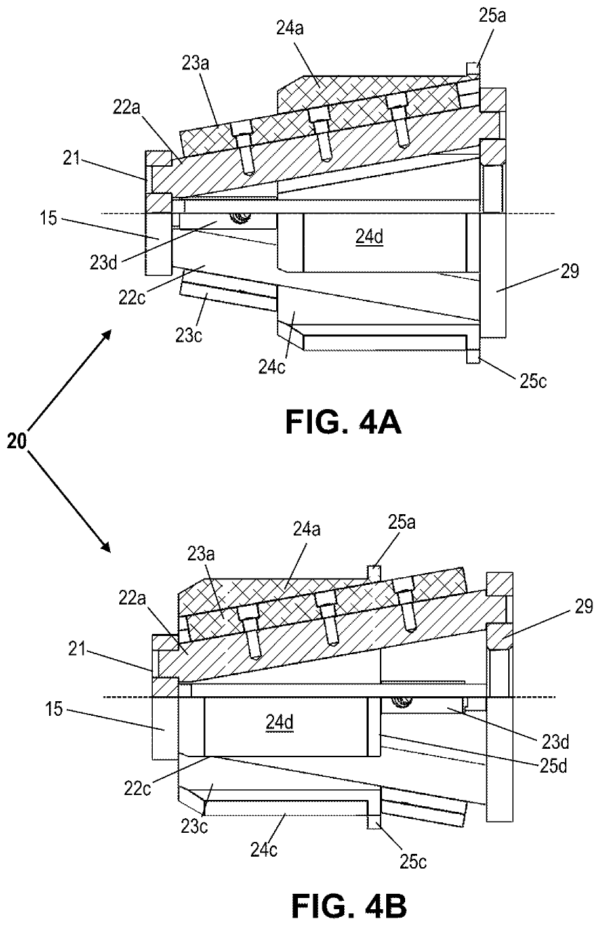

Turning now to FIGS. 2A and 2B, the inserting portion 20 of an embodiment of the tool 10 is shown in greater detail with the handling portion 12 removed for clarity. The inserting portion 20 comprises an end cap 15 and a rear cap 29. The rear cap 29 comprises an orifice 28 through which the shaft of handling portion 12 may extend; the attachment points 21 in end cap 15 are utilized for assembly (depicted in FIGS. 4A-4B). The rear cap 29 is larger than the end cap 15 to form a truncated conical shape with a positive angle from the end cap 15 to the rear cap 29. In differing embodiments, the shaft of handling portion 12 may be placed through orifice 28 loosely enough to rotate, or the shaft of handling portion 12 may be attached to the rear cap by means of, e.g., interference fit, threads, a detachable flared end, or any other mechanical means known in the art.

A set of four frame bars 22a-22d connect the end cap 15 and rear cap 29. On each respective frame bar 22a-22d are mounted rails 23a-23d. Both frame 22a-22d and rails 23a-23d are angled to meet the edge of the larger rear cap 29 and smaller end cap 15. Onto each respective rail 23a-23d is mounted a slip 24a-24d. Slips 24a-24d are mounted to rails 23a-23d such that the extend partially below rails 23a-23d to meet frame 22a-22d, enabling the end cap 15 and rear cap 29 to limit the range of motion of the slips. Each slip 24a-24d also comprises a radial portions 25a-25d which flares outward from the main body of the slips 24a-24d. FIG. 2A shows the slips 24a-24d fully retracted towards the rear cap 29, while FIG. 2B shows the slips 24a-24d in a resting position along the slanted rails 23a-23d closest to end cap 15.

In use, the inserting portion 20 of the tool 10 is inserted, in a resting position (FIG. 2B), into a tubular having an inner diameter greater than the distance between the main body of opposing slips 24a, 24d (or 24c, 24b) but less than the diameter between the radial portions of opposing slips 25a, 25d (or 25b, 25c). As the tool is inserted, the end of the tubular contacts the radial portions of the slips 25a-25d and slides the main body of the slips 24a-24d along rails 23a-23d. Eventually, as the main bodies of the slips 24a-24d are pushed out along the slant of the rails 23a-23d and make contact with the inner surface of the tubular (towards the retracted position shown in FIG. 2A). This permits the tubular to be either lifted or rolled depending on the length.

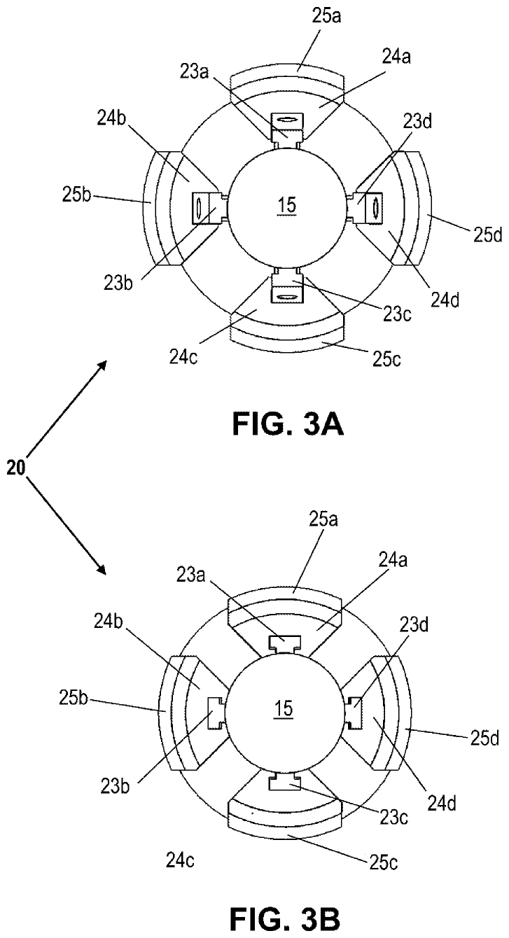

Turning now to FIGS. 3A-3B, the inserting portion 20 of the tool 10 is shown in a retracted position (FIG. 3A) and resting position (FIG. 3B) similar to FIG. 2A-2B. In this view, the rails 23a-23d of the embodiment are depicted having a T-shaped interlock, extending up from the frame 22a-22d (depicted in previous and subsequent FIGS.) with the slips 24a-24d sliding up and down the rails 23a-23d and extending into the inner portions of the T-shaped interlock, and the radial flares of the slips 25a-25d receiving the end of a tubular.

Turning now to FIGS. 4A-4B, an embodiment of the inserting portion 20 of the tool 10 is shown in a partial cross section (above the dotted line). This view depicts the frame (22a and 22c visible in the drawings) extending from the end cap 15 to the rear cap 29 with the attachment point 21 shown receiving the front end of frame bars 22a and 22c (a similar attachment point receiving the rear end of the bars is depicted in rear cap 29). In an embodiment, these may be interference fit, although other mechanical attachment means may be used by those skilled in the art.

The cross-section portions of FIGS. 4A-4B depicts the slips 24a-24d having a negatively angled body corresponding to the angle of the rails 23a-23d and frame 22a-22d. These matching angles ensure that the outer portions of the slips 24a-24d extend parallel to the longitudinal axis of the shaft 10 (shown in FIGS. 1A-1B) and evenly contact the inner diameter of the tubular to be manipulated.

In an embodiment, the end cap 15 may be removable via threads or other attachment means to permit slips 24a-24d to be removed and replaced on the tool. The rails 23a-23d are also shown in FIGS. 2A-2B and 4A-4B with bolt holes permitting easy attachment and detachment from the frame 22a-22d. Thus, the inserting portion 20 of the tool 10 may be utilized with slips and rails of differing sizes in order to accommodate different diameters of tubular.

While various embodiments usable within the scope of the present disclosure have been described with emphasis, it should be understood that within the scope of the appended claims, the present invention may be practiced other than as specifically described herein.

For instance, the round, conic shape of the inserting portion 20 may alternatively be fabricated in a triangular, pyramidal, or other polyhedral configuration, having fewer slips (e.g., 2) or more slips. Additionally, variations in the frame may be within the scope of ordinary skill in the art, for instance, the frame 22a-22d may be replaced by a mandrel having the slips located within said mandrel and extending out through orifices.

Similarly, the shapes of the interlocks on the rails 23a-23d may vary from the T-shape depicted in the embodiments. Rail interlocks may be designed to have narrower end portions such that the slips are stopped rather than abutting the end cap 15 or rear cap 29.

Still further embodiments may comprise a handle 12 having a bearing sleeve or rotatable attachment to the inserting portion 20 enabling the user to roll the tubular while maintaining a tight grip with the slips 24a-24d of the inserting portion 20.

1. A tool for manipulating a tubular comprising:
an insertion head comprising an end cap, a rear cap, and a plurality of frames connecting the end cap and the rear cap, the end cap comprising a first diameter, and the rear cap comprising a second diameter larger than the first diameter;
a plurality of rails, respectively mounted onto the plurality of frames;
a plurality of slips, respectively mounted onto the respective plurality of rails, the plurality of slips having freedom of motion along the plurality rails between the end cap and the rear cap; and
a shaft extending to the rear cap,
wherein the plurality of slips are pushed back and out along the plurality of rails when the insertion head is inserted into the tubular, such that the plurality of slips contact an inner diameter of the tubular.

2. The tool of claim 1, wherein each of the plurality of slips comprises a flared portion located at an end proximate to the rear cap, wherein the end of the tubular abuts the respective flared portions of the plurality of slips.

3. The tool of claim 1, wherein the difference between the first diameter and the second diameter defines a positive angle, wherein the plurality of rails are mounted along said positive angle, and wherein an inner surface of the plurality of slips defines a negative angle corresponding to the positive angle, such that an outer surface of each slip of the plurality of slips is parallel to the shaft.

4. The tool of claim 1, wherein the end cap comprises a plurality of assembly holes, wherein each assembly hole receives a first end of a respective frame of the plurality of frames.

5. The tool of claim 4, wherein the rear cap also comprises a plurality of assembly holes, wherein each assembly hole of the rear cap receives a second end of the respective frame of the plurality of frames.

6. The tool of claim 1, wherein the plurality of rails are T-shaped, and wherein each respective slip of the plurality of slips extends under the T-shape of the respective rail of the plurality of rails to form an interlock.

7. The tool of claim 6, wherein the end cap is detachable to permit the plurality slips to be removed by sliding them off the plurality of rails.

8. The tool of claim 1, wherein the rear cap comprises an orifice, and wherein the shaft extends through the orifice.
